(19) United States
(12) Patent Application Publication
(10) Pub. No.: US 2010/0147042 A1
(43) Pub. Date: Jun. 17, 2010

(54) CONVENIENT SLIDING GLASS DOOR INTERMEDIATE LOCK SYSTEM

(76) Inventor: Kuei Yung Chen, Taipei (TW)

Correspondence Address: JOSEPH L. STRABALA, ESQ., ONE EMBARCADERO CENTER, SUITE 1020, SAN FRANCISCO, CA, 94111, US

(21) Appl. No.: 11/957,159

(22) Filed: Dec. 14, 2007

(51) Int. Cl. E05B 65/08

(52) U.S. Cl. 70/99

(57) ABSTRACT

In a sliding glass door system, having a stationary panel and a movable panel within a door casement, the improvement of incorporating an independent locking system centrally located in the vertical stile of the movable panel remote from the conventional door lock for this panel includes an operating lever mounted in the stile so one end thereof is accessible, a vertical oriented locking bolt connected to the lever for reciprocal movement through manipulation of the lever, and a plurality of apertures in the top track of casement for the movable panel whereby the lever can be manipulated to insert the distal end of vertical locking bolt into selected apertures to lock the panel in selected intermediate positions or to remove the distal end the vertical locking bolt from such apertures to release the panel. In the preferred embodiment the connection of the lever to locking bolt and the bolt are located inside a channel in the associated stile to maintain the aesthetics of the door. Typically the lever is mounted in middle of the associated stile for added safety and convenience.

### BACKGROUND

Sliding glass doors are widely used in residential and commercial buildings. Typically the doors can only be locked in the closed position. However there are dead bolt-type accessories that can be purchased at hardware and like stores which can be attached to a moveable part (door panel) of a sliding glass door, typically by screws, see e.g., U.S. Pat. No. 6,655,720. Such accessories require apertures or grooves at the top or bottom of door casement for engagement by the lock bolt, for each intermediate position elected between an open and closed position. Such apertures or grooves can only be provided at the top or the bottom of the sliding glass door so the dead bolt must be attached at this location, making the use of such accessories very inconvenient to use, as well as unsightly.

Changes in the construction of sliding glass doors, such a the use of foamed thermoplastic extrusions for the rails and stiles of such doors, do not readily accommodate the use of such accessories due to the lack of a suitable physical structure in the rails to secure such accessories. Such extrusions are taught in U.S. Pat. Nos. 6,893,594 and 6,551,537 issued to Chen.

According to this invention, it is an object to provide a integral, intermediate sliding glass door lock which is convenient to use and maintains the aesthetics of the door and its associated casement.

Another object of this invention is the provision of a double lock for a sliding glass door, enhancing the security of such doors when locked with the normal lock and the novel system.

Still another object is the provision of a lock actuating system which cannot be reached by small children who might otherwise disengage the lock and exit into dangerous areas, such porches, patios and/or pool areas.

Other advantages and objects will be apparent from the specification and drawings of this invention.

### SUMMARY OF THE INVENTION

In a sliding glass door system, having a stationary panel and a movable panel within a door casement, the improvement of incorporating an independent locking system centrally located in the vertical stile of the movable panel remote from the conventional door lock in the opposite stile of this panel, an operating lever mounted in the stile, a vertical locking bolt connected to the lever for axially movement, and a plurality of apertures in the top track of casement for the movable panel whereby the lever can be manipulated to insert the distal end of vertical locking bolt into a selected aperture to lock the panel in a selected intermediate position or to remove the distal end the vertical locking bolt from such aperture to release the panel. In the preferred embodiment the connection of the lever to vertical locking bolt and the bolt are located inside a channel in the stile to maintain the aesthetics of the door, as well as above the middle of the stile.

### DESCRIPTION OF THE DRAWINGS

FIG. 1 is a perspective of a sliding glass door in its casement according to this invention illustrating the central location of the independent locking system;

FIG. 2 is a broken away perspective of a central portion of the stile of the moveable panel of the sliding glass door illustrating the location of the lever of the independent locking system;

FIG. 3 is broken away perspective of top portions of the door panels of the sliding glass door of FIG. 1 with a portion of the top member of the casement, and other parts illustrated exploded therefrom;

FIG. 4 is a section of the vertical stile of the moveable door panel illustrating the lever mechanism of the independent locking system in its retracted position with parts broken away; and

FIG. 5 is the same section illustrated in FIG. 4 but with the independent locking system in its extended or locking position.

### DESCRIPTION OF AN EMBODIMENT

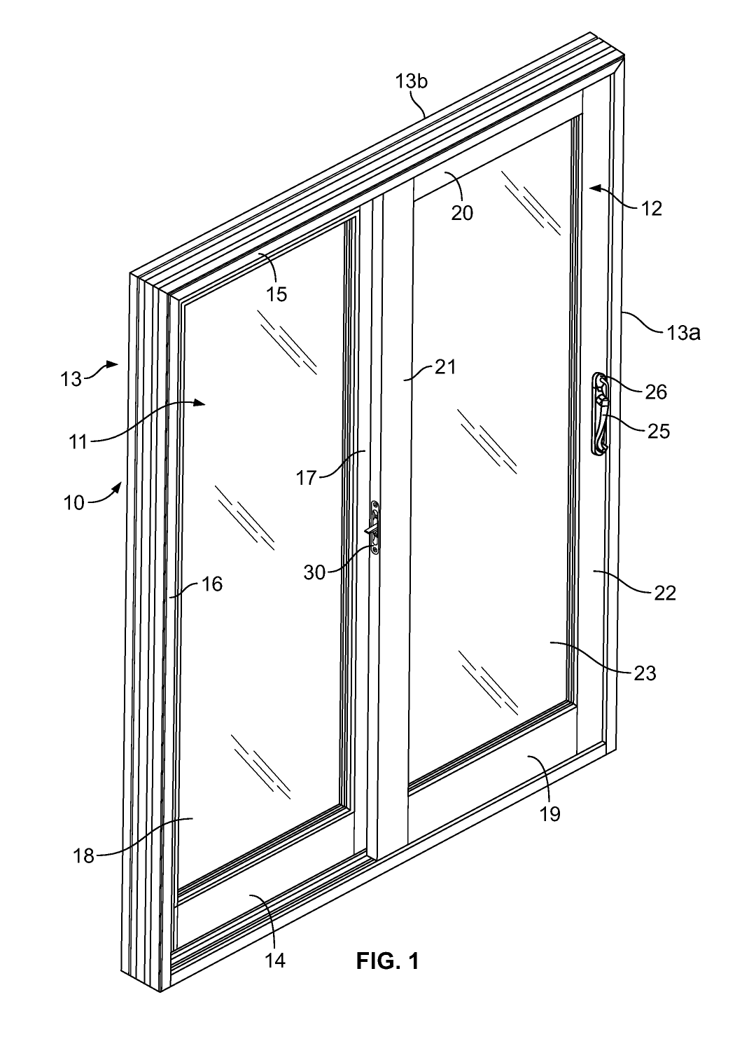

In FIG. 1 a sliding glass door unit 10 is illustrated, having a fixed glass panel 11 and a moveable glass panel 12 within its casement or frame 13. The fixed panel includes rails 14 and 15, the later being the top rail, and vertical stiles 16 and 17 assembled in a rectangular frame for supporting the glass panel 18. This panel is fixedly secured in the casement so there is no relative movement of this door panel relative to the casement.

The other glass panel 12 also includes rails 19 and 20, the latter being the top rail, and vertical stiles 21 and 22 assembled in a rectangular frame for supporting its glass panel 23. Unlike the fixed panel 11, this panel has rollers (not shown) in the bottom rail 19 so that the panel can be moved or slide between the vertical members of the casement 13.

As is typical with sliding glass doors, stile 22 of the moveable/slidable panel 12 includes a handle 25 and a lock 26 which cooperate with a typical latching structure (not shown) in the contiguous vertical member 13a of the casement 13 when the door panel is closed. This lock prevents sliding movement of the panel when engaged. As can be appreciated once this door panel moves away from the vertical member 13a of the casement it is no longer possible to engage the lock 26.

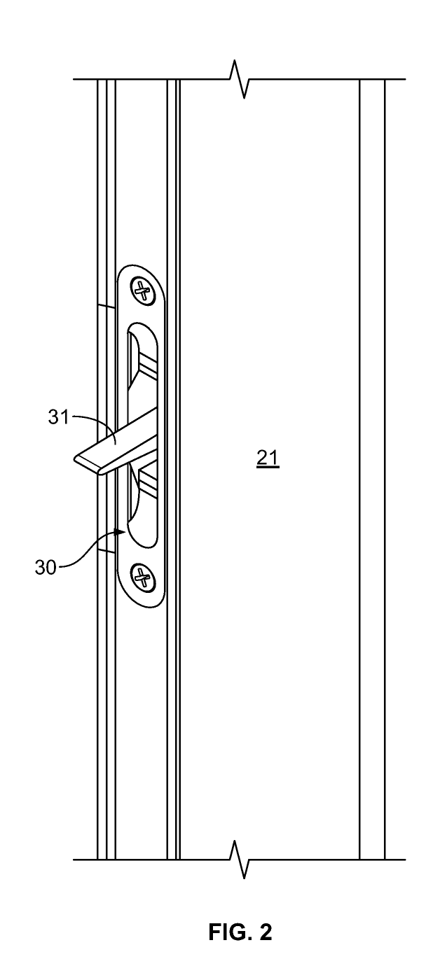

Centrally located in stile 22 of the moveable panel 12 is the operating lever 31 for the independent locking system 30 of this invention, which allows this panel to be lock in multiple intermediate positions after the panel is moved away from the vertical casement member. This part of the system is recessed in the stile as shown in FIGS. 1 and 2. By locating this portion of the locking system in the middle or higher in the vertical stile, it is very convenient to use the novel locking system, as it is not necessary to reach to the bottom or to the top of the door to employ it. Also with the operating lever at the middle or higher in the stile, small children cannot access it which is a safety feature preventing unintended release of the locked panel by small children. Such unintended release of the door panel could allow a child to venture onto a patio or into a pool with dire consequences.

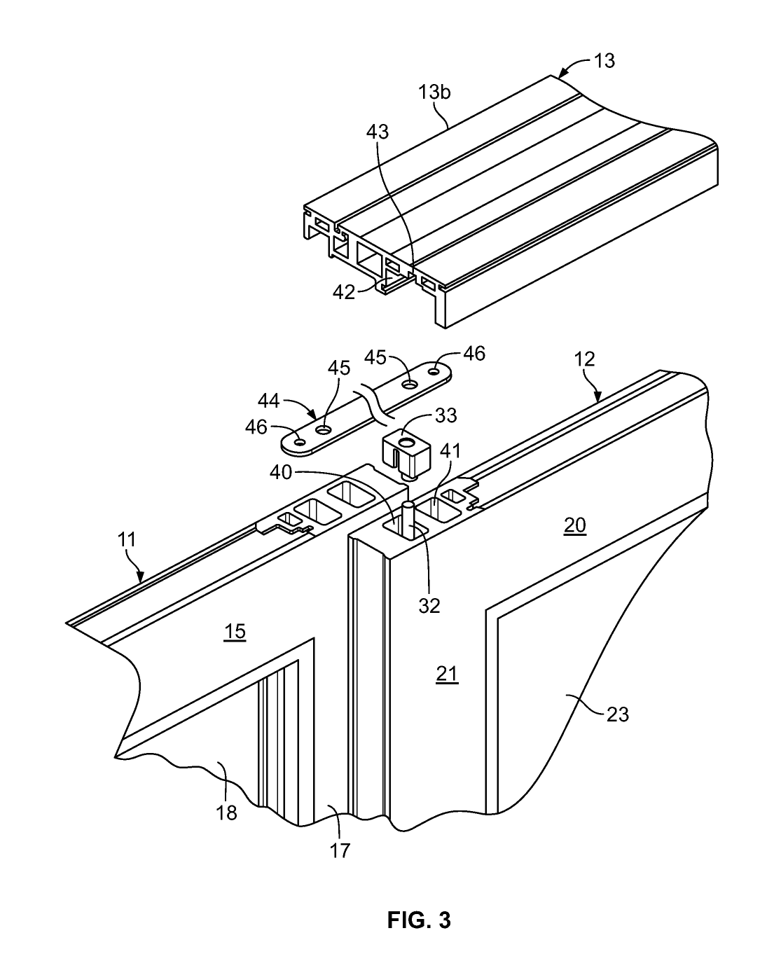

In FIG. 3 the top corner of the moveable panel 12 of the sliding glass door 10 is shown, with other parts exploded, where it can be seen that vertical stile 21 is constructed of a thermoplastic extrusion having hollow, vertical channels 40 and 41 in the stile, such as the extrusions taught in U.S. Pat. Nos. 6,893,594 and 6,551,537 issued to Chen. Channel 40 can be utilized for the parts of the independent locking system 30 by using it to accommodate a vertical locking bolt 32. The distal end of this bolt is supported for reciprocating movement in a bearing member 33 that fits into the top of channel 40. Engagement of his bearing in the channel provides structural integration of the bolt with the stile and ensures physical integrity so the bolt will be able to withstand considerable shear loadings when necessary to prevent movement of the locked panel. The top horizontal member 13b of the casement 13 has a track 42 in which the top of the moveable door panel 12 slides when the door is opened and closed. A central groove 43 is provided in this track as shown in FIG. 3 and metal plate 44 having a plurality of apertures 45, sized to receive the end of the bolt 32, is attached to top of the track so the apertures register with the groove 43 allowing the end of the bolt to pass through these apertures into the groove when the system locks the panel. When the plate is attached to the top of the track by screws or the like (not shown) through holes 46, moveable door panel 12 will be locked when the distal end of the bolt is one of the apertures. Using the plate insures a physically secure lock when the bolt is in one of the apertures and by longitudinally adjusting the plate the bolt can be used to augment the normal lock 26 when the door is closed and or adjusted in the field. For example, if it is desired the door panel be locked in a particular partial open position, the metal plate can be repositioned to that the such a position is accommodate. While this embodiment of the lock system is preferred, an alternate embodiment can be used by drilling holes in the top of track 42 in place of the groove 43; however, when using extruded components of thermoplastics excessive wear may be experienced in this embodiment which is avoided when using the metal plate described herein.

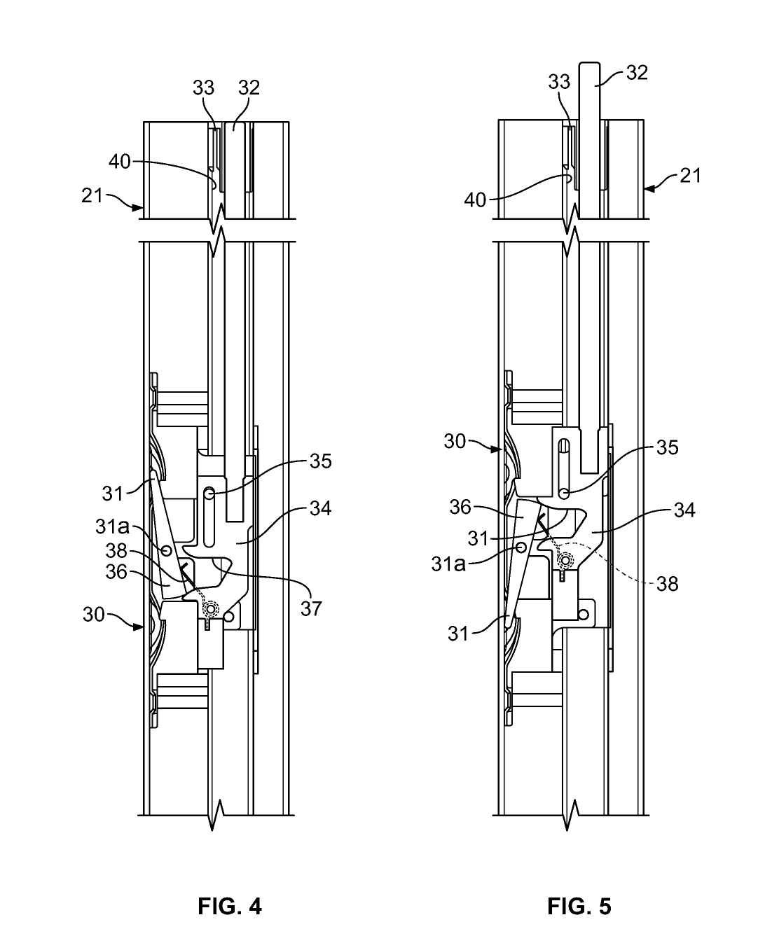

Operation of the independent locking systems 30 is accomplished by lever 31 which is pivoted in stile 21 on journal 31a, as can be seen in FIGS. 4 and 5. In FIG. 4 the system is disengaged, that is bolt 32 is retracted. The bolt is controlled by a shuttle plate 34 that connects to the bottom end of the bolt. The shuttle plate includes an aperture for guide pin 35 that allows the bolt to be reciprocated vertically by the lever, the internal end 36 of which engages a cam opening 37 in the shuttle plate. Through this cam arrangement the shuttle plate is moved up and down by the lever as it pivots about its journal 31a. A spring 38 on the shuttle plate engages the internal end of the lever to bias it in both the lock bolt up and the lock bolt down positions.

The current independent lock system 30 is highly advantageous in sliding glass doors wherein the casement 13 and the rails and stiles of the door components are made from thermoplastic extrusions, since service life is not diminished when the system is installed and a clean, aesthetic appealing sliding glass door structure can be obtained. Further any number of apertures 45 can be provided in the metal plate 44 so that the moveable door panel 12 can be locked in multiple intermediate positions between full open and full closed.

Having described my invention, I claim:

1. An improved intermediate lock system for a sliding glass door having a casement enclosing two glass door panels composed of rails and stiles which secures one panel in a stationary position and provides tracks for the other panel to slide back and forth along the horizontal members of the casement along with a conventional lock for the other panel in the stile which engages a vertical member of the casement when the panel in the closed comprising;
an operating lever mounted for articulation and centrally located said stile of said other panel which stile is remote from said stile having the conventional lock for the door of said panel;
a vertical channel in said stile having said lever mounted therein with one end of said lever communicating with such channel;
a movable bolt located in such vertical channel with its bottom end operably engaged by said lever and operable to reciprocate said distal end of said bolt so that said distal end projects from the top of said stile in one position of said lever and is recessed below the top of said stile in the other position of said lever;
aperture means in said top horizontal track of said casement operable to receive said distal end of said bolt when its distal end extends above the top of its associated stile to lock said panel against sliding movement until the distal end of said bolt is retracted from such aperture means.

2. The improved intermediate lock system defined in claim 1 wherein the rails and stiles of the door panels are constructed of extruded components having hollow channels therein.

3. The improved intermediate lock system defined in claim 1 wherein the aperture means is an elongated metal plate with a plurality of holes for receiving the distal end of the bolt and is mounted in the top of the horizontal track of the casement in which the movable panel slides.

4. The improved intermediate lock system defined in claim 1 wherein the bottom end of the bolt is reciprocated by a cam means operably connected to said bottom of said bolt and engaged by one end of the lever to reciprocate said bolt.
